(19) United States
(12) Patent Application Publication
(10) Pub. No.: US 2024/0407342 A1
(43) Pub. Date: Dec. 12, 2024

(54) METHOD, SYSTEM, AND DEVICE FOR CLASSIFYING FEEDING INTENSITY OF FISH SCHOOL

(71) Applicant: China Agricultural University, Beijing (CN)

(72) Inventors: Daoliang LI, Beijing (CN); Zhuangzhuang DU, Beijing (CN); Cong WANG, Beijing (CN); Xianbao XU, Beijing (CN); Zhuangzhuang BAI, Beijing (CN); Yang HU, Beijing (CN); Chuanyu SUN, Beijing (CN); Bingxiong WANG, Beijing (CN); Shuaixing WANG, Beijing (CN)

(21) Appl. No.: 18/638,173

(22) Filed: Apr. 17, 2024

(30) Foreign Application Priority Data
Jun. 6, 2023 (CN) 202310657873.9

(51) Int. Cl. A01K 61/95; G10L 25/18; G10L 25/21; G10L 25/30; G10L 25/51

(52) U.S. Cl. CPC A01K 61/95; G10L 25/18; G10L 25/21; G10L 25/30; G10L 25/51

(57) ABSTRACT

Provided are a method, system and device for classifying feeding intensity of fish school, relating to the field of aquaculture. The method includes: extracting features of an audio clip to be detected to determine a Mel spectrum-based fish school feeding depth speech spectrum feature vector, a CQT-based fish school feeding depth speech spectrum feature vector, and an STFT-based fish school feeding depth speech spectrum feature vector; fusing the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram; and inputting the fused feature spectrogram into a deep convolutional neural network model constructed by historical audio clips corresponding to different types of feeding intensities to determine a feeding intensity type corresponding to the audio clip to be detected.

### CROSS-REFERENCE TO RELATED APPLICATION

This patent application claims the benefit and priority of Chinese Patent Application No. 202310657873.9 filed with the China National Intellectual Property Administration on Jun. 6, 2023, the disclosure of which is incorporated by reference herein in its entirety as part of the present application.

### TECHNICAL FIELD

The present disclosure relates to the field of aquaculture, and in particular to a method, system and device for classifying feeding intensity of fish school.

### BACKGROUND

In aquaculture, the feeding quantity of bait is always an important issue that limits the economic benefits of aquaculture, and thus it is of a great significance to control bait feeding reasonably. At this stage, feeding decision mostly rely on the experience of aquaculture personnel to set the feeding quantity of bait, and the influence of fish feeding demand, water quality environment and the like are ignored, which leads to water pollution and resource waste caused by insufficient or excessive feeding. Therefore, there is an urgent need to develop an automatic fish school feeding intensity recognition method based on feeding demands of fish, so as to achieve contactless and real-time feeding intensity classification, which is crucial for further development of self-demand feeding system.

### SUMMARY

An objective of the present disclosure is to provide a method, system and device for classifying feeding intensity of fish school, so as to solve the problems of water pollution and resource waste caused by insufficient or excessive feeding in manual feeding methods.

To achieve the above objective, the present disclosure provides the following technical solution:

A method for classifying feeding intensity of fish school includes:
extracting features of an audio clip to be detected to determine a Mel spectrum-based fish school feeding depth speech spectrum feature vector, a Constant-Q Transform (CQT)-based fish school feeding depth speech spectrum feature vector, and an Short-Time Fourier Transform (STFT)-based fish school feeding depth speech spectrum feature vector;
fusing the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram; and
inputting the fused feature spectrogram into a deep convolutional neural network model constructed by historical audio clips corresponding to different types of feeding intensities to determine a feeding intensity type corresponding to the audio clip to be detected, where the feeding intensity type comprises “strong”, “medium”, “weak” and “none”.

In the embodiment, extracting the Mel spectrum-based fish school feeding depth speech spectrum feature vector includes:
arranging a plurality of triangular filters in a frequency range of a fish school feeding sound signal to form a triangular frequency filter bank, where the triangular frequency filter bank comprises a plurality of band-pass filters, the band-pass filters are Mel filters, a transfer function of each band-pass filter is:

$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$

where Hₘ(k) is the band-pass filter, m is a serial number of a Mel filter, M is the number of Mel filters, f(m) is a center frequency of a m-th Mel filter, f(m+1) is a center frequency of a (m+1)-th Mel filter, and f(m−1) is a center frequency of a (m−1)-th Mel filter;
performing fast Fourier transform on a sound signal in the audio clip to be detected using the triangular frequency filter bank, and converting the sound signal from a time domain to a frequency domain, so as to generate a filtered sound signal;
determining an energy spectrum according to the filtered sound signal;
determining signal energy in each Mel filter according to the energy spectrum;
determining a Mel spectrum map of the fish school feeding sound signal according to the signal energy; and
extracting the Mel spectrum-based fish school feeding depth speech spectrum feature vector in the audio clip to be detected according to the Mel spectrogram.

In the embodiment, extracting the CQT-based fish school feeding depth speech spectrum feature vector includes:
performing constant-Q transform on a sound signal in the audio clip to be detected to generate spectral parameters after constant-Q transform;
generating a constant-Q transform spectrum map according to the spectral parameters; and
extracting the CQT-based fish school feeding depth speech spectrum feature vector in the audio clip to be detected according to the constant-Q transform spectrogram.

In the embodiment, extracting the STFT-based fish school feeding depth speech spectrum feature vector includes:
adding a short-time window function moving along time axis to a sound signal in the audio clip to be detected, and intercepting a non-stationary signal at each moment by the short-time window function, where a signal within a short-time window is a stationary signal;
performing Fourier transform on the non-stationary signal to generate a time-frequency spectrum of each moment; and
extracting the STFT-based fish school feeding depth speech spectrum feature vector in the audio clip to be detected according to the time-frequency spectrum.

In the embodiment, constructing the deep convolutional neural network model includes:
acquiring historical video clips and historical sound signals of the fish school before, during and after feeding, respectively;
dividing different types of feeding intensities according to the historical video clips, and synchronously clipping the historical sound signals to determine the historical audio clips corresponding to different types of feeding intensities; and
constructing the deep convolutional neural network model according to the historical audio clips.

A system for classifying feeding intensity of fish school includes:
a feature extraction module, configured to extract features of an audio clip to be detected to determine a Mel spectrum-based fish school feeding depth speech spectrum feature vector, a CQT-based fish school feeding depth speech spectrum feature vector, and an STFT-based fish school feeding depth speech spectrum feature vector;
a feature fusion module, configured to fuse the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram; and
a feeding intensity type determination module, configured to input the fused feature spectrogram into a deep convolutional neural network model constructed by historical audio clips corresponding to different types of feeding intensities to determine a feeding intensity type corresponding to the audio clip to be detected, where the feeding intensity type comprises “strong”, “medium”, “weak” and “none”.

In the embodiment, the feature extraction module includes:
a triangular frequency filter bank arrangement unit, configured to arrange a plurality of triangular filters in a frequency range of a fish school feeding sound signal to form a triangular frequency filter bank, where the triangular frequency filter bank comprises a plurality of band-pass filters, the band-pass filters are Mel filters, a transfer function of each band-pass filter is:

$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$

where Hₘ(k) is the band-pass filter, m is a serial number of a Mel filter, M is a number of the Mel filters, f(m) is a center frequency of a m-th Mel filter, f(m+1) is a center frequency of a (m+1)-th Mel filter, and f(m−1) is a center frequency of a (m−1)-th Mel filter;
a fast Fourier transform processing unit, configured to perform fast Fourier transform on a sound signal in the audio clip to be detected using the triangular frequency filter bank, and to covert the sound signal from a time domain to a frequency domain, so as to generate a filtered sound signal;
an energy spectrum determination unit, configured to determine an energy spectrum according to the filtered sound signal;
a signal energy determination unit, configured to determine signal energy in each Mel filter according to the energy spectrum;
a Mel spectrogram determination unit, configured to determine a Mel spectrogram of the fish school feeding sound signal according to the signal energy; and
a Mel spectrum-based fish school feeding depth speech spectrum feature vector extraction unit, configured to extract the Mel spectrum-based fish school feeding depth speech spectrum feature vector in the audio clip to be detected according to the Mel spectrogram.

In the embodiment, the feature extraction module includes:
a spectral parameter generating unit after constant Q transform, configured to perform constant-Q transform on a sound signal in the audio clip to be detected to generate spectral parameters after constant-Q transform;
a constant-Q transform spectrogram generation unit, configured to generate a constant-Q transform spectrogram according to the spectral parameters; and
a CQT-based fish school feeding depth speech spectrum feature vector extraction unit, configured to extract the CQT-based fish school feeding depth speech spectrum feature vector in the audio clip to be detected according to the constant-Q transform spectrogram.

An electronic device includes a memory and a processor. A computer program is stored in the memory, and the processor runs the computer program to enable the electronic device to execute the above method for classifying feeding intensity of fish school.

A computer readable storage medium is provided. A computer program is stored in the computer readable storage medium, and the computer program, when executed by a processor, realizes the above method for classifying feeding intensity of fish school.

According to the specific embodiment provided by the present disclosure, the present disclosure discloses the following technical effects: a method, system and device for classifying feeding intensity of fish school are provided. Video clips and sound signals are combined, and based on Mel spectrum, Constant-Q Transform (CQT) and Short-Time Fourier Transform (STFT), features of the combined audio clip to be detected are extracted to generate different fish school feeding depth speech spectrum feature vectors, and the different fish school feeding depth speech spectrum feature vectors are fused, and the fused feature spectrogram is input into a deep convolutional neural network model constructed by historical audio clips corresponding to different types of feeding intensities, so as to determine a feeding intensity type corresponding to the audio clip to be detected. By combining the video clips and the sound signals, feeding is carried out according to the feeding intensity type and the feeding demand of fish school, automatic on-demand feeding is achieved, and water pollution and resource waste caused by insufficient or excessive feeding are avoided.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a flow chart of a method for classifying feeding intensity of fish school according to the present disclosure;

FIG. 2 is a flow chart of a Convolutional Neural Network (CNN)-based method for classifying feeding intensity of fish school according to the present disclosure;

FIG. 3 is a structural diagram of an experimental data acquisition system according to the present disclosure;

FIG. 4 are pictures of parts of samples showing different feeding intensity types in a fish school feeding data set according to the present disclosure;

FIG. 5 are pictures of feature maps of a fish school feeding intensity according to the present disclosure;

FIG. 6A and FIG. 6B are comparative diagrams of the traditional network structure and an improved CNN network model according to the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The purpose of the present disclosure is to provide a method, system and device for classifying feeding intensity of fish school. The automatic on-demand feeding is achieved, and the problems of water pollution and resource waste caused by insufficient or excessive feeding are solved.

In order to make the objectives, features and advantages of the present disclosure more clearly, the present disclosure is further described in detail below with reference to the embodiments.

Sound recognition is a frontier topic in pattern recognition theory today, covering many fields. At present, some sound recognition topics have made remarkable research progress, such as automatic speech recognition (ASR), music information retrieval (MIR), bird audio detection (BAD), environmental sound classification (ESC) and abnormal cardiac sound diagnosis. Pulsed acoustic signals produced by fish and shrimp during eating can be used as the judging criteria for their eating activities. Detection by passive acoustic methods will not have a negative impact on the feeding environment and feeding behavior of the fish and shrimp, and can provide a basis for formulating more effective feeding strategies, thus making the feeding system conform to the feeding needs of different fish populations. Therefore, research on feeding behavior of fish school based on acoustics technology is an important means for quantifying feeding intensity of fish school.

Feature fusion is a common fusion method, which is widely used in image recognition, speech recognition, sound scene classification, and other tasks. In recent years, with rapid development of deep learning, the feature fusion has been widely used in many fields and achieved good performance. At present, more scholars pay attention to the fusion of image features or the combination of acoustic and image features. Previous studies have shown that Mel-frequency cepstral coefficients (MFCC) features can be fused by a convolutional neural network (CNN) model to create a fusion of acoustic features and visual features, which can achieve good results. Considering advantages of the feature fusion algorithm, a method for classifying feeding intensity based on the feature fusion of feeding sound signals of fish school is provided by the present disclosure. This method has an important guiding significance for further development of a self-demand feeding decision system.

### Embodiment 1

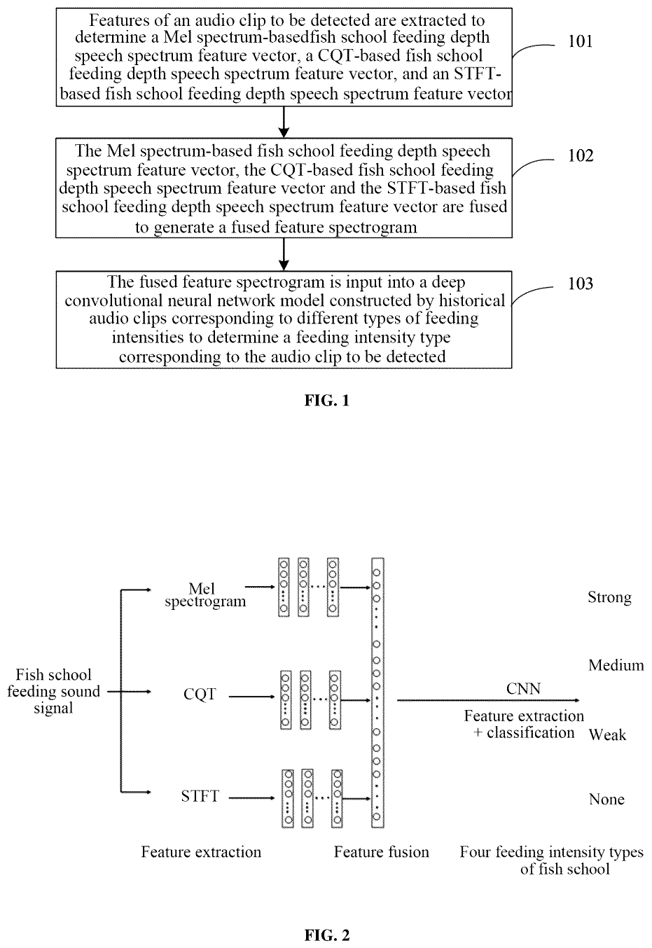

As shown in FIG. 1 and FIG. 2, a method for classifying feeding intensity of fish school includes steps 101 to 103:

In step 101, features of an audio clip to be detected are extracted to determine a Mel spectrum-based fish school feeding depth speech spectrum feature vector, a CQT-based fish school feeding depth speech spectrum feature vector, and an STFT-based fish school feeding depth speech spectrum feature vector.

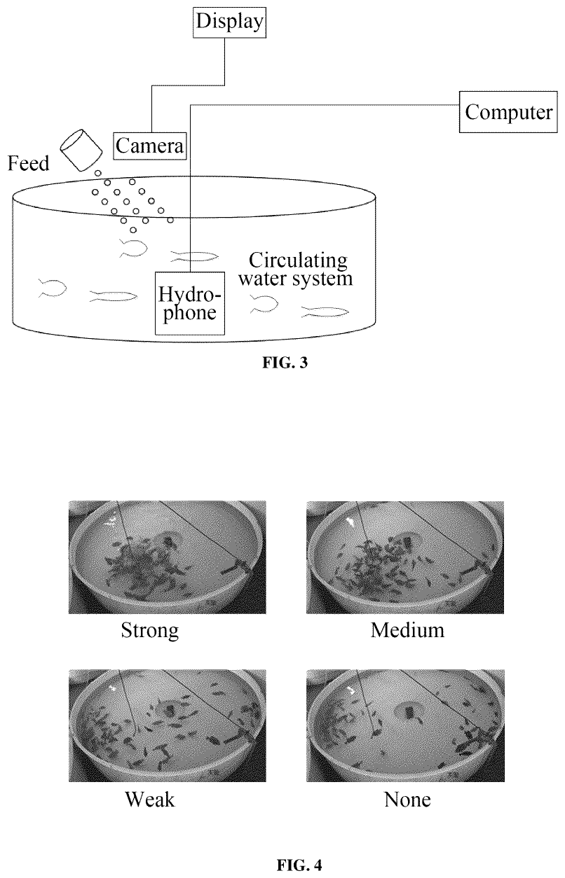

In practical applications, prior to Step 101, as shown in FIG. 3, a Hikvision vision camera and an omni-directional hydrophone are used to obtain video clips and sound signals of the fish school before, during and after feeding.

According to the experience of aquaculture technicians and the existing standards for classifying feeding intensity, the feeding intensity video of fish is divided into four types by watching the replay of the video, which are “strong”, “medium”, “weak”, and “none”, as shown in FIG. 4. Afterwards, according to the classification intensity and time period of the video, the synchronized sound signals are clipped in the same way to obtain audio clips of the four feeding intensity types.

For the audio clip of each feeding intensity type, a training set, a verification set and a testing set are created according to a certain proportion by randomly selecting audio clips, and a deep convolutional neural network model is constructed according to the training set.

In practical applications, an extraction process of the Mel spectrum-based fish school feeding depth speech spectrum feature vector includes the following steps:

Mel frequency is a nonlinear frequency inspired by human auditory characteristics. A logarithmic relationship between a sound frequency and the Mel frequency is described in Equation (1), where fₘₑₗ is the Mel frequency, and f is an actual frequency in Hz.

$${f}_{mel} = 2 \; 597 lg ( 1 + \frac{f}{700} ) \qquad ( 1 )$$

A triangular frequency filter bank is used to imitate human ears to filter speech signals. M triangular filters are arranged in a frequency range of a fish feeding signal to form a triangular frequency filter bank.

The triangular frequency filter bank consists of 64 band-pass filters Hₘ(k). The band-pass filters are Mel filters, a transfer function of each Mel filter is shown in Equation (2), where 1≤m≤M, m is the serial number of the Mel filter, M is the number of Mel filters, f(m) is the center frequency of the m-th Mel filter, f(m+1) is the center frequency of the (m+1)-th Mel filter, and f(m−1) is the center frequency of the (m−1)-th Mel filter.

$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} , \qquad ( 2 )$$

As shown in Equation (3), fₗ and fₕ are the lowest and highest frequencies of the filter, respectively, fₛ is a sampling frequency, N is a length of fast Fourier transform (FFT), and fₘₑₗ is a perceptual frequency of Mel, fₘₑₗ⁻¹ is an inverse function of fₘₑₗ. In the present disclosure, fₛ is set to be 22050, fₗ>0, fₕ is set to be half of fₛ, and N is set to be 2048.

$$f ( m ) = ( \frac{N}{{f}_{s}} ) {f}_{mel}^{- 1} [ {f}_{mel} ( {f}_{l} ) + m \frac{{f}_{mel} ( {f}_{h} ) - {f}_{mel} ( {f}_{l} )}{M + 1} ] \qquad ( 3 )$$

The triangular frequency filter bank, after being designed, is used to perform FFT on a feeding signal y(n), so as to convert a time domain signal to a frequency domain. And the feeding signal is a feeding sound signal in the audio clip to be detected. As shown in Equation (4), k represents a k-th spectral line in the frequency domain.

$$X ( i , k ) = {\sum }_{n = 0}^{N - 1} y ( n ) {e}^{- h \frac{2 π kn}{N}} , 0 \leq k \leq N \qquad ( 4 )$$

An energy spectrum E(i, k) is obtained by the square of X(i, k) after FFT, with an expression calculated as follows:

$$E ( i , k ) = {[ X ( i , k ) ]}^{2} \qquad ( 5 )$$

Afterwards, the obtained energy spectrum passes through M Mel filter banks to obtain the signal energy in each Mel filter S(i, m).

$$S ( i , m ) = {\sum }_{k = 0}^{N - 1} E ( i , k ) {H}_{m} ( k ) , 0 \leq m < M \qquad ( 6 )$$

By adopting the above methods and steps, an (M×N)-order matrix containing the information of signal energy magnitude can be obtained, and the Mel spectrogram of the fish feeding signals can be obtained by coloring according to the one-to-one mapping relationship between the energy magnitude and shade of color.

In practice applications, an extraction process of the STFT-based fish school feeding depth speech spectrum feature vector includes the following steps:

In the field of digital signal processing, short-time Fourier transform (STFT) is one of the commonly used signal processing methods, which plays an important role in the field of time-frequency analysis.

STFT is to add a short-time window function that moves along the time axis to the signal, and to intercept a non-stationary signal near each moment by a short-time window. At this time, a signal in the short-time window can be regarded as a stationary signal. The interception results are respectively subjected to Fourier transform to obtain a frequency spectrum near each moment, i.e., a time-frequency spectrum.

A signal after STFT processing has localization characteristics in time domain and frequency domain, and thus can be used to analyze the time-frequency characteristics of the signal. The STFT can increase the temporal dimension by dividing the non-stationary signal into multiple frames containing quasi-stationary portions, and can reduce sidelobes in the spectrum by using the window function. As shown in Equation (7), s[n] represents an audio signal with a window length of L, and w[t] represents the short-time window function. In this operation, the sampling rate is set to be 22050, the L is set to be 2048, hop count is set to be 512, and the number of desired output levels is set to be 12.

$$STFT [ f , t ] = {\sum }_{n = 0}^{L - 1} s [ n ] \cdot w [ t ] {e}^{- j 2 π fn} \qquad ( 7 )$$

In practical applications, extracting the CQT-based fish school feeding depth speech spectrum feature vector includes:

Constant-Q transform (CQT) employs a logarithmically spaced frequency interval, which can make a Q factor in the whole spectrum constant (Q factor is the ratio of central frequency to a bandwidth). Compared with Fourier transform, constant-Q transform makes a low frequency band in the spectrum have relatively high frequency resolution and a high frequency band in the spectrum have relatively high time resolution. The window length of constant-Q transform will change with the change of frequency.

A speech is converted from a time domain to a frequency domain by constant-Q transform, and a ratio of the center frequencies of two adjacent components in the constant-Q transform remains unchanged. The center frequency of the k-th component is shown in the following equation, where fₖ represents the center frequency of the k-th component, fₘᵢₙ represents the center frequency of the first component, i.e., the sound with the smallest frequency in the whole spectrum, and β represents the number of spectral lines in each octave. Herein, β is set to be 36, and fₘᵢₙ is set to be 32.7 Hz.

$${f}_{k} = {f}_{min} {2}^{\frac{k - 1}{β}} \qquad ( 8 )$$

The constant-Q factor in the k-th component is the ratio of the center frequency to the bandwidth. Q, which is a constant, is suitable for all components in the spectrum. As shown in the following equation. fₖ₊₁−fₖ represents the bandwidth of the k-th component, as can been seen from the equation, the value of the Q factor is only related to β.

$$Q = \frac{{f}_{k}}{{f}_{k + 1} - {f}_{k}} = \frac{1}{{2}^{1 / β} - 1} \qquad ( 9 )$$

The window length Nₖ of the k-th frequency band varies with the frequency and is inversely proportional to the center frequencies f of k filters, where Nₖ is determined by the following equation, where fₛ represents a sampling frequency. Herein, fₛ is set to be 22050.

$${N}_{k} = \frac{{f}_{s}}{{f}_{k}} Q \qquad ( 10 )$$

Finally, a speech signal x(m) is subjected to constant-Q transform, and the frequency component of the k-th octave of the N-th frame after transformation is determined by the following equation. W_{N}_{ₖ}(m) represents the window function, and x^{cqt}(k) represents the spectral parameters after constant-Q transform.

$${X}^{cqt} ( k ) = \frac{1}{{N}_{k}} {\sum }_{n = 0}^{{N}_{k} - 1} x ( m ) {w}_{{N}_{k}} ( m ) {e}^{\frac{- j 2 mnQ}{{N}_{k}}} \qquad ( 11 )$$

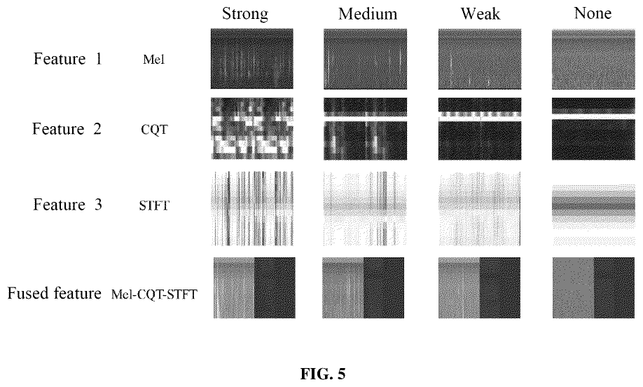

The frequency range of vocal organs of human is mostly concentrated in low frequency, and the common time-frequency conversion method for signals is STFT. STFT may have the problems such as periodical truncation at lower frequencies, leading to low frequency resolution of speech. Compared with STFT, Mel spectrum and CQT can provide frequency analysis on logarithmic scale, which can solve the problem of low frequency resolution well, provide higher resolution for the low frequency and reflect the characteristics of the original sound more completely. Based on the diversity of features, it is considered that it is feasible to provide different features for classification. FIG. 5 shows a STFT spectrogram, a Mel spectrum, a CQT spectrogram, and a fused feature map. In addition, the Mel spectrum, CQT spectrogram and STFT have not been used as part of CNN model for the recognition of feeding intensity of the fish school.

In step 102, the Mel spectrum-based fish school feeding depth speech spectrum feature vector, the CQT-based fish school feeding depth speech spectrum feature vector and the STFT-based fish school feeding depth speech spectrum feature vector are fused to generate a fused feature spectrogram.

In step 103, the fused feature spectrogram is input into a deep convolutional neural network model constructed by historical audio clips corresponding to different types of feeding intensities to determine a feeding intensity type corresponding to the audio clip to be detected. The feeding intensity type includes “strong”, “medium”, “weak” and “none”.

In practical applications, the Mel spectrum-based fish school feeding depth speech spectrum feature vector, the CQT-based fish school feeding depth speech spectrum feature vector and the STFT-based fish school feeding depth speech spectrum feature vector are fused, and then an improved CNN network model is used for classification.

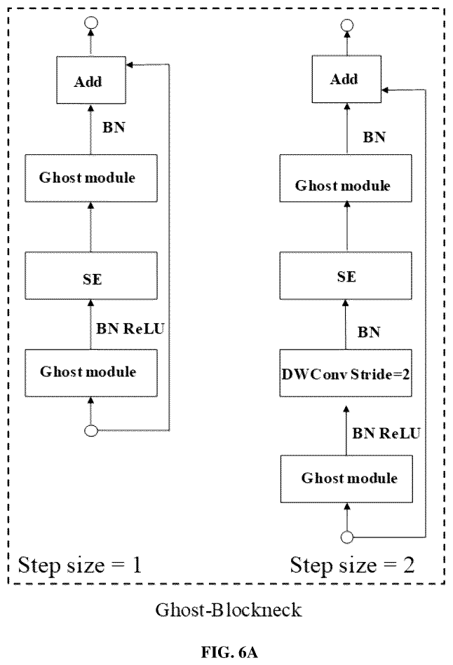

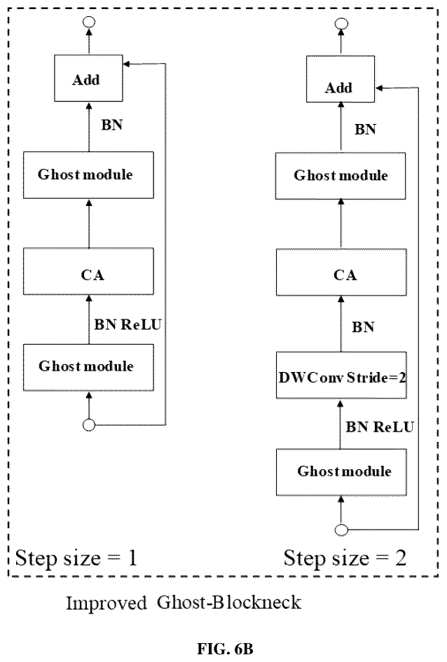

In practical applications, the fused feature spectrogram generated after transformation is used as an input of a pre-training deep convolutional neural network module, and the task of classifying feeding intensity of fish school is finished by using the improved CNN network. The improvement scheme is shown in FIG. 6A and FIG. 6B, an SE attention mechanism (Squeeze-and-Exclusion Networks) module of a Ghost-Blockneck module in a GhostNet model is replaced with a CA attention mechanism (Coordinate attention) module.

In the present disclosure, accuracy, precision, recall and F1-score are used to assess the fish feeding activity intensity classification (Equations 12-15), where true positive (TP) means that the positive class is determined to be positive, false positive (FP) means that the negative class is determined to be positive, false negative (FN) means that the positive class is determined to be negative, and true negative (TN) means the number of negative samples correctly classified. The four assessment indexes are defined as follows:

$$\begin{matrix}Accuracy = \frac{TP + FN}{TP + FN + FP + TN} \times 100 \% & ( 12 ) \\ Precision = \frac{TP}{TP + FP} \times 100 \% & ( 13 ) \\ Recall = \frac{TP}{TP + FN} \times 100 \% & ( 14 ) \\ F 1 - score = \frac{2 \times Precision \times Recall}{Precision + Recall} \times 100 \% & ( 15 )\end{matrix}$$

Mel, CQT and STFT features of the feeding speech are extracted through a Librosa library, then several different acoustic features are fused, and the fused feeding feature spectrogram is input into a fine-tuned convolutional neural network for deep feature extraction and classification, thus obtaining a classification result. This method not only optimizes and fuses different feeding audio features, but also improves the attention mechanism module of the Ghost-Blockneck module in the GhostNet model. Compared with the existing algorithm, the accuracy of fish school feeding sound recognition is significantly improved.

### Embodiment 2

In order to execute the method corresponding to Embodiment 1 to achieve corresponding functions and technical effects, a system for classifying feeding intensity of fish school is provided below.

A system for classifying feeding intensity of fish school includes a feature extraction module, a feature fusion module and a feeding intensity type determination module.

The feature extraction module is configured to extract features of an audio clip to be detected to determine a Mel spectrum-based fish school feeding depth speech spectrum feature vector, a CQT-based fish school feeding depth speech spectrum feature vector, and an STFT-based fish school feeding depth speech spectrum feature vector.

The feature fusion module is configured to fuse the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram.

The feeding intensity type determination module is configured to input the fused feature spectrogram into a deep convolutional neural network model constructed by historical audio clips corresponding to different types of feeding intensities to determine a feeding intensity type corresponding to the audio clip to be detected, where the feeding intensity type comprises “strong”, “medium”, “weak” and “none”.

In practical applications, the feature extraction module includes a triangular frequency filter bank arrangement unit, a fast Fourier transform processing unit, an energy spectrum determination unit, a signal energy determination unit, a Mel spectrogram determination unit and a Mel spectrum-based fish school feeding depth speech spectrum feature vector extraction unit.

The triangular frequency filter bank arrangement unit is configured to arrange a plurality of triangular filters in a frequency range of a fish school feeding sound signal to form a triangular frequency filter bank, where the triangular frequency filter bank comprises a plurality of band-pass filters, the band-pass filters are Mel filters, a transfer function of each band-pass filter is:

$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$

where Hₘ(k) is the band-pass filter, m is the serial number of the Mel filter, M is the number of Mel filters, f(m) is center frequency of the m-th Mel filter, f(m+1) is center frequency of a (m+1)-th Mel filter, and f(m−1) is center frequency of a (m−1)-th Mel filter.

The fast Fourier transform processing unit is configured to perform fast Fourier transform on a sound signal in the audio clip to be detected using the triangular frequency filter bank, and to covert the sound signal from a time domain to a frequency domain, so as to generate a filtered sound signal.

The energy spectrum determination unit is configured to determine an energy spectrum according to the filtered sound signal.

The signal energy determination unit is configured to determine signal energy in each Mel filter according to the energy spectrum.

The Mel spectrogram determination unit is configured to determine a Mel spectrogram of the fish school feeding sound signal according to the signal energy.

The Mel spectrum-based fish school feeding depth speech spectrum feature vector extraction unit is configured to extract the Mel spectrum-based fish school feeding depth speech spectrum feature vector in the audio clip to be detected according to the Mel spectrogram.

In practical applications, the feature extraction module includes a spectral parameter generating unit, a constant-Q transform spectrogram generation unit and a CQT-based fish school feeding depth speech spectrum feature vector determination unit,

The spectral parameter generating unit after constant Q transform is configured to perform constant-Q transform on the sound signal in the audio clip to be detected to generate spectral parameters after constant-Q transform, The constant-Q transform spectrogram generation unit is configured to generate a constant-Q transform spectrogram according to the spectral parameters. The CQT-based fish school feeding depth speech spectrum feature vector extraction unit is configured to extract the CQT-based fish school feeding depth speech spectrum feature vector in the audio clip to be detected according to the constant-Q transform spectrogram.

### Embodiment 3

An electronic device provided by an embodiment of the present disclosure includes a memory and a processor. The memory is configured to store a computer program, and the processor runs the computer program to enable the electronic device to execute the method for classifying feeding intensity of fish school provided by Embodiment 1.

In practical applications, the electronic device may be a processor.

In practical applications, the electronic device includes at least one processor, a memory, a bus, and a communications interface.

The processor, the communications interface and the memory communicate with one another through the communication bus.

The communication interface is configured to communicate with other devices.

The processor is configured to execute the program, specifically, the method of the above embodiment.

Specifically, the program may include a program code, and the program code includes a computer operation instruction.

The processor may be a central processing unit (CPU), or an application specific integrated circuit (ASIC), or one or more integrated circuits configured to implement the embodiment of the present disclosure. The electronic device includes one or more processors, which may be the same type of processor, e.g., one or more CPUs, or different types of processors, e.g., one or more CPUs and one or more ASICs.

The memory is configured to store the program. The memory may include a high-speed RAM (random-access memory), and may also include non-volatile memory, such as at least one disk memory.

Based on the description of the above embodiments, a storage medium on which computer program instructions are stored is provided by the embodiments of the present disclosure, and the computer program instructions may be executed by the processor to achieve the method described in any embodiment.

The system for classifying feeding intensity of fish school provided by the embodiment of the present disclosure exists in various forms, including but not limited to:
(1) Mobile communication devices. Such devices are characterized by mobile communication function, with a main goal of providing voice and data communication. Such terminals include: smart phones (e.g., iPhone), multimedia phones, functional phones, and low-end mobiles.
(2) Ultra-mobile personal computer devices. Such devices belong to the category of personal computers, which have calculation and processing functions and generally have mobile internet access performance. Such terminals include: PDA (Personal Digital Assistant), MID (Mobile Internet Device) and UMPC (Ultra-mobile Personal Computer) devices, such as iPad.
(3) Portable entertainment devices. Such devices can display and play multimedia content. Such devices include: audio and video players (e.g., iPod), portable game consoles, e-books, smart toys and portable car navigation devices.
(4) Other electronic devices with data interaction function.

So far, specific embodiments of the present subject matter have been described. Other embodiments are within the scope of the appended claims. In some cases, the actions recited in the claims can be executed in a different order and still achieve the desired results. In addition, the processes depicted in the drawings do not necessarily require the specific order shown or the sequential order to achieve the desired results. In some embodiments, multi-task processing and parallel processing may be advantageous.

The system, apparatus, module or unit set forth in the above embodiments can be specifically achieved by computer chips or entities, or by products with certain functions. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device or a combination of any of these devices.

For the convenience of description, the previous apparatus is described by dividing the functions into various units. Certainly, when the present disclosure is implemented, the functions of each unit can be implemented in the same or multiple pieces of software and/or hardware. Those skilled in the art should understand that the embodiments of the present disclosure may be provided as methods, systems, or computer program products. Therefore, the present disclosure may use a form of an entire hardware embodiment, an entire software embodiment or an embodiment combining software and hardware. Moreover, the present disclosure may use a form of a computer program product that is implemented on one or more computer-usable storage media (including but not limited to a disk memory, a CD-ROM, an optical memory, and the like) that include computer-usable program codes.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of the process and/or block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, so the instructions stored in the computer readable memory can generate an artifact including an instruction apparatus. The instruction apparatus is configured to implement functions specified in one or more processes in the flowcharts and/or in one or more blocks in the block diagrams.

These computer program instructions may also be loaded onto a computer or other programmable data processing devices, such that a series of operational steps are performed on the computer or other programmable devices to produce a computer-implemented process, and the instructions executed on the computer or other programmable devices can provide steps for implementing the functions specified in one or more processes in the flowcharts and/or in one or more blocks in the block diagrams.

In a typical configuration, a computing device includes one or more processors (CPU), input/output interfaces, a network interface, and a memory.

The memory may include forms such as a non-persistent storage in a computer readable medium, a random-access memory (RAM) and/or a non-volatile memory, such as a read-only memory (ROM) or a flash memory (flash RAM). The memory is an example of the computer readable medium.

The computer readable medium includes a persistent and a non-persistent, a removable and a non-removable medium, which can implement information storage by using any method or technology. The information may be a computer readable instruction, a data structure, a module of a program, or other data. Examples of a storage medium of a computer include, but are not limited to: a phase change random-access memory (PRAM), a static random-access memory (SRAM), a dynamic random-access memory (DRAM), other types of random-access memory (RAM), a read-only memory (ROM), an electrically erasable programmable read-only memory (EEPROM), a flash memory or another memory technology, a compact disc-read only memory (CD-ROM), a digital versatile disc (DVD) or another optical storage device, a cassette tape, a disk storage, or other magnetic storage devices, or

any other non-transmission media, which may be configured to store the information that can be accessed by the computing device. According to the definition of the present disclosure, the computer readable medium does not include a transitory medium (transitory media), such as a modulated data signal and a modulated carrier.

It should be further noted that, the terms “include”, “comprise”, or their any other variant is intended to cover a non-exclusive inclusion, thus making a process, a method, a product, or a device including a list of elements not only include those elements but also include other elements which are not expressly listed, or further include elements inherent to such a process, method, product, or device. An element preceded by the sentence “includes a . . . ” does not, without more constraints, exclude the existence of additional identical elements in the process, method, product, or device that includes the element.

The present disclosure may be described in the general context of the computer executable instructions executed by a computer, for example, a program module. Generally, the program module includes a routine, a program, an object, a component, a data structure, and the like for executing a particular task or implementing a particular abstract data type. The present disclosure may also be practiced in a distributed computing environment in which tasks are performed by remote processing devices that are connected by a communications network. In the distributed computing environment, program modules may be located in both local and remote computer storage media including storage devices.

Various embodiments in this specification are described in a progressive way, and each embodiment focuses on the differences from other embodiments, so it is only necessary to refer to the same and similar parts between the embodiments. Since the system disclosed by the embodiments corresponds to the method disclosed by the embodiments, the description is relatively simple, and the reference is made to the descriptions in the method for related parts.

Specific examples are used herein for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A method for classifying feeding intensity of fish school, comprising:
extracting features of an audio clip to be detected to determine a Mel spectrum-based fish school feeding depth speech spectrum feature vector, a Constant-Q Transform (CQT)-based fish school feeding depth speech spectrum feature vector, and a Short-Time Fourier Transform (STFT)-based fish school feeding depth speech spectrum feature vector;
fusing the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram; and
inputting the fused feature spectrogram into a deep convolutional neural network model constructed by historical audio clips corresponding to different types of feeding intensities to determine a feeding intensity type corresponding to the audio clip to be detected, wherein the feeding intensity type comprises “strong”, “medium”, “weak” and “none”.

2. The method according to claim 1, wherein extracting the Mel spectrum-based fish school feeding depth speech spectrum feature vector comprises:
arranging a plurality of triangular filters in a frequency range of a fish school feeding sound signal to form a triangular frequency filter bank, wherein the triangular frequency filter bank comprises a plurality of band-pass filters, the band-pass filters are Mel filters, a transfer function of each band-pass filter is:
$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$
wherein Hₘ(k) is the band-pass filter, m is a serial number of a Mel filter, M is a number of the Mel filters, f(m) is a center frequency of a m-th Mel filter, f(m+1) is a center frequency of a (m+1)-th Mel filter, and f(m−1) is a center frequency of a (m−1)-th Mel filter;
performing fast Fourier transform on a sound signal in the audio clip to be detected using the triangular frequency filter bank, and converting the sound signal from a time domain to a frequency domain, so as to generate a filtered sound signal;
determining an energy spectrum according to the filtered sound signal;
determining signal energy in each Mel filter according to the energy spectrum;
determining a Mel spectrogram of the fish school feeding sound signal according to the signal energy; and
extracting the Mel spectrum-based fish school feeding depth speech spectrum feature vector in the audio clip to be detected according to the Mel spectrogram.

3. The method according to claim 1, wherein extracting the CQT-based fish school feeding depth speech spectrum feature vector comprises:
performing constant-Q transform on a sound signal in the audio clip to be detected to generate spectral parameters after constant-Q transform;
generating a constant-Q transform spectrogram according to the spectral parameters; and
extracting a CQT-based fish school feeding depth speech spectrum feature vector in the audio clip to be detected according to the constant-Q transform spectrogram.

4. The method according to claim 1, wherein extracting the STFT-based fish school feeding depth speech spectrum feature vector comprises:
adding a short-time window function moving along time axis to a sound signal in the audio clip to be detected, and intercepting a non-stationary signal at each moment by the short-time window function, wherein a signal within a short-time window is a stationary signal;
performing Fourier transform on the non-stationary signal to generate a time-frequency spectrum of each moment; and
extracting the STFT-based fish school feeding depth speech spectrum feature vector in the audio clip to be detected according to the time-frequency spectrum.

5. The method according to claim 1, wherein constructing the deep convolutional neural network model comprises:
acquiring historical video clips and historical sound signals of the fish school before, during and after feeding, respectively;
dividing different types of feeding intensities according to the historical video clips, and synchronously clipping the historical sound signals to determine the historical audio clips corresponding to different types of feeding intensities; and
constructing the deep convolutional neural network model according to the historical audio clips.

6. A system for classifying feeding intensity of fish school, comprising:
a feature extraction module, configured to extract features of an audio clip to be detected to determine a Mel spectrum-based fish school feeding depth speech spectrum feature vector, a CQT-based fish school feeding depth speech spectrum feature vector, and an STFT-based fish school feeding depth speech spectrum feature vector;
a feature fusion module, configured to fuse the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram; and
a feeding intensity type determination module, configured to input the fused feature spectrogram into a deep convolutional neural network model constructed by historical audio clips corresponding to different types of feeding intensities to determine a feeding intensity type corresponding to the audio clip to be detected, wherein the feeding intensity type comprises “strong”, “medium”, “weak” and “none”.

7. The system according to claim 6, wherein the feature extraction module comprises:
a triangular frequency filter bank arrangement unit, configured to arrange a plurality of triangular filters in a frequency range of a fish school feeding sound signal to form a triangular frequency filter bank, wherein the triangular frequency filter bank comprises a plurality of band-pass filters, the band-pass filters are Mel filters, a transfer function of each band-pass filter is:
$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$
wherein Hₘ(k) is the band-pass filter, m is a serial number of a Mel filter, M is a number of the Mel filters, f(m) is a center frequency of a m-th Mel filter, f(m+1) is a center frequency of a (m+1)-th Mel filter, and f(m−1) is a center frequency of a (m−1)-th Mel filter;
a fast Fourier transform processing unit, configured to perform fast Fourier transform on a sound signal in the audio clip to be detected using the triangular frequency filter bank, and to covert the sound signal from a time domain to a frequency domain, so as to generate a filtered sound signal;
an energy spectrum determination unit, configured to determine an energy spectrum according to the filtered sound signal;
a signal energy determination unit, configured to determine signal energy in each Mel filter according to the energy spectrum;
a Mel spectrogram determination unit, configured to determine a Mel spectrogram of the fish school feeding sound signal according to the signal energy; and
a Mel spectrum-based fish school feeding depth speech spectrum feature vector extraction unit, configured to extract the Mel spectrum-based fish school feeding depth speech spectrum feature vector in the audio clip to be detected according to the Mel spectrogram.

8. The system according to claim 6, wherein the feature extraction module comprises:
a spectral parameter generating unit after constant Q transform, configured to perform constant-Q transform on a sound signal in the audio clip to be detected to generate spectral parameters after constant-Q transform;
a constant-Q transform spectrogram generation unit, configured to generate a constant-Q transform spectrogram according to the spectral parameters; and
a CQT-based fish school feeding depth speech spectrum feature vector extraction unit, configured to extract the CQT-based fish school feeding depth speech spectrum feature vector in the audio clip to be detected according to the constant-Q transform spectrogram.

9. An electronic device, comprising a memory and a processor, wherein a computer program is stored in the memory, and the processor runs the computer program to enable the electronic device to execute following steps:
extracting features of an audio clip to be detected to determine a Mel spectrum-based fish school feeding depth speech spectrum feature vector, a Constant-Q Transform (CQT)-based fish school feeding depth speech spectrum feature vector, and a Short-Time Fourier Transform (STFT)-based fish school feeding depth speech spectrum feature vector;
fusing the Mel spectrum-based fish school feeding depth speech spectrum feature vector, the CQT-based fish school feeding depth speech spectrum feature vector and the STFT-based fish school feeding depth speech spectrum feature vector to generate a fused feature spectrogram; and
inputting the fused feature spectrogram into a deep convolutional neural network model constructed by historical audio clips corresponding to different types of feeding intensities to determine a feeding intensity type corresponding to the audio clip to be detected, wherein the feeding intensity type comprises “strong”, “medium”, “weak” and “none”.

10. The electronic device according to claim 9, wherein extracting the Mel spectrum-based fish school feeding depth speech spectrum feature vector comprises:
arranging a plurality of triangular filters in a frequency range of a fish school feeding sound signal to form a triangular frequency filter bank, wherein the triangular frequency filter bank comprises a plurality of band-pass filters, the band-pass filters are Mel filters, a transfer function of each band-pass filter is:
$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$
wherein Hₘ(k) is the band-pass filter, m is a serial number of a Mel filter, M is a number of the Mel filters, f(m) is a center frequency of a m-th Mel filter, f(m+1) is a center frequency of a (m+1)-th Mel filter, and f(m−1) is a center frequency of a (m−1)-th Mel filter;
performing fast Fourier transform on a sound signal in the audio clip to be detected using the triangular frequency filter bank, and converting the sound signal from a time domain to a frequency domain, so as to generate a filtered sound signal;
determining an energy spectrum according to the filtered sound signal;
determining signal energy in each Mel filter according to the energy spectrum;
determining a Mel spectrogram of the fish school feeding sound signal according to the signal energy; and
extracting the Mel spectrum-based fish school feeding depth speech spectrum feature vector in the audio clip to be detected according to the Mel spectrogram.

11. The electronic device according to claim 9, wherein extracting the CQT-based fish school feeding depth speech spectrum feature vector comprises:
performing constant-Q transform on a sound signal in the audio clip to be detected to generate spectral parameters after constant-Q transform;
generating a constant-Q transform spectrogram according to the spectral parameters; and
extracting a CQT-based fish school feeding depth speech spectrum feature vector in the audio clip to be detected according to the constant-Q transform spectrogram.

12. The electronic device according to claim 9, wherein extracting the STFT-based fish school feeding depth speech spectrum feature vector comprises:
adding a short-time window function moving along time axis to a sound signal in the audio clip to be detected, and intercepting a non-stationary signal at each moment by the short-time window function, wherein a signal within a short-time window is a stationary signal;
performing Fourier transform on the non-stationary signal to generate a time-frequency spectrum of each moment; and
extracting the STFT-based fish school feeding depth speech spectrum feature vector in the audio clip to be detected according to the time-frequency spectrum.

13. The electronic device according to claim 9, wherein constructing the deep convolutional neural network model comprises:
acquiring historical video clips and historical sound signals of the fish school before, during and after feeding, respectively;
dividing different types of feeding intensities according to the historical video clips, and synchronously clipping the historical sound signals to determine the historical audio clips corresponding to different types of feeding intensities; and
constructing the deep convolutional neural network model according to the historical audio clips.

14. A computer readable storage medium, wherein a computer program is stored in the computer readable storage medium, and the computer program, when executed by a processor, realizes the method according to claim 1.

15. The computer readable storage medium according to claim 14, wherein extracting the Mel spectrum-based fish school feeding depth speech spectrum feature vector comprises:
arranging a plurality of triangular filters in a frequency range of a fish school feeding sound signal to form a triangular frequency filter bank, wherein the triangular frequency filter bank comprises a plurality of band-pass filters, the band-pass filters are Mel filters, a transfer function of each band-pass filter is:
$${H}_{m} ( k ) = \{ \begin{matrix}0 & k < f ( m - 1 ) \\ \frac{k - f ( m - 1 )}{f ( m ) - f ( m - 1 )} & f ( m - 1 ) \leq k \leq f ( m ) \\ \frac{f ( m + 1 ) - k}{f ( m + 1 ) - f ( m )} & f ( m ) < k < f ( m + 1 ) \\ 0 & k > f ( m + 1 )\end{matrix} ,$$
wherein Hₘ(k) is the band-pass filter, m is a serial number of a Mel filter, M is a number of the Mel filters, f(m) is a center frequency of a m-th Mel filter, f(m+1) is a center frequency of a (m+1)-th Mel filter, and f(m−1) is a center frequency of a (m−1)-th Mel filter;
performing fast Fourier transform on a sound signal in the audio clip to be detected using the triangular frequency filter bank, and converting the sound signal from a time domain to a frequency domain, so as to generate a filtered sound signal;
determining an energy spectrum according to the filtered sound signal;
determining signal energy in each Mel filter according to the energy spectrum;
determining a Mel spectrogram of the fish school feeding sound signal according to the signal energy; and
extracting the Mel spectrum-based fish school feeding depth speech spectrum feature vector in the audio clip to be detected according to the Mel spectrogram.

16. The computer readable storage medium according to claim 14, wherein extracting the CQT-based fish school feeding depth speech spectrum feature vector comprises:
performing constant-Q transform on a sound signal in the audio clip to be detected to generate spectral parameters after constant-Q transform;
generating a constant-Q transform spectrogram according to the spectral parameters; and
extracting a CQT-based fish school feeding depth speech spectrum feature vector in the audio clip to be detected according to the constant-Q transform spectrogram.

17. The computer readable storage medium according to claim 14, wherein extracting the STFT-based fish school feeding depth speech spectrum feature vector comprises:
adding a short-time window function moving along time axis to a sound signal in the audio clip to be detected, and intercepting a non-stationary signal at each moment by the short-time window function, wherein a signal within a short-time window is a stationary signal;
performing Fourier transform on the non-stationary signal to generate a time-frequency spectrum of each moment; and
extracting the STFT-based fish school feeding depth speech spectrum feature vector in the audio clip to be detected according to the time-frequency spectrum.

18. The computer readable storage medium according to claim 14, wherein constructing the deep convolutional neural network model comprises:
acquiring historical video clips and historical sound signals of the fish school before, during and after feeding, respectively;
dividing different types of feeding intensities according to the historical video clips, and synchronously clipping the historical sound signals to determine the historical audio clips corresponding to different types of feeding intensities; and
constructing the deep convolutional neural network model according to the historical audio clips.
